(19) United States
(12) Patent Application Publication
(10) Pub. No.: US 2021/0146667 A1
(43) Pub. Date: May 20, 2021

(54) INHIBITION OF BOND-LINE READ-THROUGH IN JOINED DUAL LAYER THERMOSET ARTICLES

(71) Applicant: CONTINENTAL STRUCTURE PLASTICS, INC., Auburn Hills, MI (US)

(72) Inventors: Adam Burley, Auburn Hills, MI (US); Rene Hanna, Auburn Hills, MI (US); Michael Siwajek, Auburn Hills, MI (US)

(73) Assignee: Continental Structure Plastics, Inc., Auburn Hills, MI (US)

(21) Appl. No.: 16/623,810

(22) PCT Filed: Jun. 19, 2018
(86) PCT No.: PCT/US2018/038316

§ 371 Date: Dec. 18, 2019

Related U.S. Application Data
(60) Provisional application No. 62/521,899, filed on Jun. 19, 2017.

(51) Int. Cl. B32B 27/20; B32B 27/36; B32B 7/12; B32B 27/08; B60R 13/04

(52) U.S. Cl. CPC B32B 27/20; B32B 27/36; B32B 7/12; B32B 27/08; B60R 13/04; B32B 2262/101; B32B 2307/406; B32B 2605/00; B32B 2255/10; B32B 2250/02; B32B 2250/244; B32B 2260/021; B32B 2260/046; B32B 2262/106

(57) ABSTRACT

A vehicle component including a first cured layer of a molding composition having chopped glass fibers as a majority by volume of the fiber filler. A second cured layer of molding composition is provided that has carbon fibers as a majority by volume of the fiber filler. An adhesive applied is as liquid or paste joining the first cured layer and the second cured layer. The adhesive has a Modulus of between 600 and 800 MPa with an elongation of about 70% as determined by ASTM D638 and a CLTE between 50 and 90 μm/m-° C. in a temperature range of −30° C. to 0° C. and 255 μm/m-° C. in a temperature range of 100° C. to 130° C. as determined by ISO MAT-2208, and a thickness such that no bond-line read-through (BLRT) is observable in an outer surface of said first cured layer with an unaided, normal human eye.

### RELATED APPLICATIONS

This application claims priority benefit of the U.S. Provisional Application Ser. No. 62/521,899 filed 19 Jun. 2017; the contents of which are hereby incorporated by reference.

### FIELD OF THE INVENTION

The present invention in general relates to composites and in particular to adhesives that inhibit bond-line read-through in bonded assemblies.

### BACKGROUND OF THE INVENTION

Weight savings in the automotive, transportation, and logistics based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

Composite materials are engineered or naturally occurring materials made from two or more constituent materials with significantly different physical or chemical properties which remain separate and distinct at the macroscopic or microscopic scale within the finished structure. There are two categories of constituent materials: matrix and reinforcement. At least one portion of each type is required. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

Commercially produced composites often use a polymer matrix material often called a resin solution. There are many different polymers available depending upon the starting raw ingredients which may be placed into several broad categories, each with numerous variations. Examples of the most common categories for categorizing polymers include polyester, vinyl ester, epoxy, phenolic, polyimide, polyamide, polypropylene, PEEK, and others.

The use of fiber inclusions and commonly ground minerals to strengthen a matrix is well known to the art. Well established mechanisms for the strengthening include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM); hereafter referred to collectively as “molding compositions”, fiber strengthening has traditionally involved usage of chopped glass fibers. There is a growing appreciation in the field of molding compositions that replacing in part, or all of the glass fiber in molding compositions with carbon fiber can provide improved component properties.

The use of carbon fibers in composites, sheet molding compositions, and resin transfer molding (RTM) results in formed components with a lower weight as compared to glass fiber reinforced materials. The weight savings achieved with carbon fiber reinforcement stems from the fact that carbon has a lower density than glass and produces stronger and stiffer parts at a given thickness.

Fiber-reinforced composite materials can be divided into two main categories normally referred to as short fiber-reinforced materials and continuous fiber-reinforced materials. Continuous reinforced materials often constitute a layered or laminated structure. The woven and continuous fiber styles are typically available in a variety of forms, being pre-impregnated with the given matrix (resin), dry, uni-directional tapes of various widths, plain weave, harness satins, braided, and stitched. Various methods have been developed to reduce the resin content of the composite material, by increasing the fiber content. Typically, composite materials may have a ratio that ranges from 60% resin and 40% fiber to a composite with 40% resin and 60% fiber content. The strength of a product formed with composites is greatly dependent on the ratio of resin to reinforcement material.

High quality surface finishes, such as a class-A surfaces in the auto industry are characterized by a high surface sheen, and are generally obtained only with highly tailored resin formulations that contain glass fibers, such as TCA® resins commercially available from Continental Structural Plastics, Inc. used in SMC or RTM, or metals such as aluminum and alloys thereof. Surfaces without visible distortions are generally required for vehicle surface panels: doors, hoods, quarter panels, trunks, roof structures, bumpers, etc., which make up a significant amount of weight in a vehicle.

As thermoset and thermoplastics are increasingly being used to make vehicle body panels, in order to achieve both weight reduction and the high surface sheen many such parts are formed with two components: an inner portion that is carbon fiber rich and imparts high strength and weight reduction, laminated to an outer portion that is glass fiber rich and contributes the attribute of high surface sheen. In order to join these portions together adhesives are used that have considerable requirements as to strength and flexibility over a range of temperatures and the lifetime of a vehicle. However, an attribute of conventional adhesives is bond-line read-through (BLRT) with about a 1 mm thick outer portion puckering around the adhesive bond line, and is a major source of distortions in bonded class-A assemblies.

BLRT is generally related to the use of adhesives to bond composite assemblies, and may be related to the elevated temperatures to cure the bond adhesive. While BLRT does not affect the structural integrity of the bonded assembly, the diminished appearance of the exposed body panel is generally unacceptable. While an easy solution to fix BLRT is to increase the thickness of a body panel, the increase in thickness would also increase the weight of the panel as well as the amount and cost of material used to form the panel. Research has focused on minimizing BLRT while maintaining or lowering the thicknesses of class-A outer body panels.

Industry practices that have been employed to avoid BLRT have included matching mechanical and thermal properties (e.g., coefficients of thermal expansion (CTE)) of bonded assemblies, using adhesives with low shrinkage, maintaining constant joint thickness of applied adhesive, avoidance of mold-in spacers between bond flanges, avoidance of adhesive squeeze out, controlling cure temperatures to avoid thermal damage to composite surfaces, and providing constant cure conditions across an assembly to be bonded. Fernholz, K. D. “The influence of bond dam design and hard hits on bond-line read-through severity.” SPE Automotive Composites Conference, Trov, Mi. 2010. demonstrated the distortion caused by panel joinder with adhesives and if standoffs or other mechanical features could preclude this effect of outer surface BLRT.

While there have been many advances in controlling bond-line read-through there continues to be a need for improved bonding adhesives that inhibit bond-line read-through.

### SUMMARY OF THE INVENTION

A vehicle component including a first cured layer of a molding composition having chopped glass fibers as a majority by volume of the fiber filler. A second cured layer of molding composition is provided that has carbon fibers as a majority by volume of the fiber filler. An adhesive applied is as liquid or paste joining the first cured layer and the second cured layer. The adhesive has a Modulus of between 600 and 800 MPa with an elongation of about 70% as determined by ASTM D638 and a CLTE between 50 and 90 μm/m-° C. in a temperature range of −30° C. to 0° C. and 255 μm/m-° C. in a temperature range of 100° C. to 130° C. as determined by ISO MAT-2208, and a thickness such that no bond-line read-through (BLRT) is observable in an outer surface of said first cured layer with an unaided, normal human eye.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C are perspective views of a two-piece vehicle hood with an outer layer of glass fiber reinforced class-A sheet material, and an inner layer of carbon fiber reinforced sheet molding compositions or carbon reinforced resin transfer molding (RTM) bonded with BLRT control adhesives according to embodiments of the invention;

FIG. 2 shows the vehicle hood of FIGS. 1A-1C formed with a glass fiber reinforced finished surface outer panel (see-thru surface) bonded with BLRT control adhesives at multiple points to a carbon fiber reinforced structural inner panel according to embodiments of the invention; and

FIG. 3 is a cross section of a typical body panel seal flange where the glass fiber based class A outer panel is bonded with BLRT control adhesives at a bond flange of the carbon fiber based structural inner panel according to embodiments of the invention.

### DESCRIPTION OF THE INVENTION

The present invention has utility as bond-line read-through (BLRT) control adhesives for use in the formation of two-piece vehicle components that are reinforced with chopped and dispersed glass fibers in one cured layer and a joined second cured layer reinforced with dispersed carbon fibers. While the present invention is detailed herein as relating to a two-piece construction, it should be appreciated that the two-piece structure described herein is readily repeated to create a multiple layer laminate. By way of example, a predominantly glass fiber filled outer skin layer is joined to opposing surfaces of a core predominantly carbon fiber filled core layer; vice versa; or a series of alternating predominantly fiber filled layers are joined with a pattern A-B-A . . . B. In certain inventive embodiments, a cured inner portion of molding composition is reinforced predominantly with chopped carbon fibers is joined to a cured outer skin of a second sheet molding composition reinforced predominantly with glass fiber, where the outer surface has an automotive surface quality finish, such as a high gloss finish as measured by automotive production standards. As used herein, a high gloss finish is associated with a surface shine and reflectivity required for exterior body panels by automotive manufacturers. In a particular inventive embodiment, the cured inner portion is substantially devoid of glass fiber, while the outer skin is substantially devoid of chopped carbon fiber. It should also be appreciated that other composite bonded structures with compositions not described herein that require a class-A outer finish may also be used with embodiments of the inventive BLRT control adhesives.

As used herein “molding compositions” refers to SMC, BMC and RTM resin formulations that are amenable to loading with chopped fibers of glass or carbon.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Embodiments of the inventive BLRT control adhesives demonstrate low heat distortion, low chemical shrinkage, have fast controllable cure speeds, while continuing to provide excellent surface adhesion. Embodiments of the BLRT control adhesives have low shrinkage for maintaining constant joint thickness of the applied adhesive. The BLRT control adhesives have lower cure temperatures to help avoid thermal damage to composite surfaces, and are amenable to constant cure conditions across an assembly to be bonded.

According to the present invention, polymeric adhesives are used to bond the outer portion and the inner portion, each with a different CLTE. The polymeric adhesives in the form of a liquid or paste and in contrast to conventional adhesive tapes such as 3M™ VHB™.

While polymeric adhesives can be based on a variety of cure moieties such as epoxy, urethanes, and acrylics. An inventive adhesive has a glass transition temperature, Tg that is above 94 degrees Celsius and in some embodiments between 107 and 210 degrees Celsius. Without intending to be bound to a particular theory, adhesives above Tg soften rapidly with increasing temperature.

As used herein modulus is defined as the ratio of stress over strain, where strain=is the change in linear dimension over the initial linear dimension. For an adhesive, the strain is assumed to be the CLTE x change in temperature (ΔT). With the assumption that the CLTE of the inner and outer panels are small compared to the adhesive, the stress on the joint is simply: Stress=Modulus×CLTE(adhesive)×ΔT.

As a result, an adhesive is selected that has a Modulus of about 680 MPa with an elongation of about 70% as determined by ASTM D638, and a CLTE of about 72 μm/m-° C. in a temperature range of −30° C. to 0° C. and 255 μm/m-° C. in a temperature range of 100° C. to 130° C. as determined by ISO MAT-2208.

In typical applications, the adhesive have a cured thickness of between 400 and 1500 microns. Ann inventive article is thus formed that has a glass-fiber enriched outer layer with a thickness of between 1800 and 2800 microns, and a carbon-fiber enriched inner layer with a thickness of between 700 and 2500 microns. Thicknesses of the various layers are readily measured directly by cross-sectional optical light microscopy.

The resulting dual layer part with a liquid or paste inventive adhesive, as opposed to a tape, has a BLRT that is not visible to the unaided, normal human eye as measured at 20° C. An inventive adhesive in some inventive embodiments is able to retain a level of distortion such that BLRT that is not visible to the unaided, normal human eye at 20° C. after being cycled between −40° C. and 40° C. In still other inventive embodiments, is able to retain a level of distortion such that BLRT that is not visible to the unaided, normal human eye across the temperature range of between −40° C. and 40° C.

Embodiments of the inventive BLRT control adhesive are presented in table 1.

TABLE 1
Properties of some commercial adhesives.
{highlighted have been tested}

| Material | Modulus (GPa) | Elongation | CLTE |
|---|---|---|---|
| Supplier A-adhesive 1 | 2.80 | 3 | 204 |
| Supplier A- adhesive 2 | 0.73 | 16 | 156 |
| Supplier B- adhesive 1 | 1.76 | 11 | 268 |
| Supplier B- adhesive 2 | 0.68 | 73 | 255 |
| Supplier B- adhesive 3 | 1.49 | 22 | 275 |
| Supplier B- adhesive 4 | 1.32 | 29 | 252 |
| Suppler B- adhesive 5 | 3.02 | 2 | 207 |

In a particular inventive embodiment, used with the inventive BLRT control adhesive, carbon fibers in a molding composition are present in an inner layer of a vehicle component containing from 10 to 40% by weight carbon fibers of the inner layer, with an outer skin layer of SMC based on the commercially available TCA® (Continental Structural Plastics, Inc.) containing glass fiber containing between 10 and 60% glass fiber by weight of the TCA® portion, as embodied in U.S. Pat. No. 7,655,297. The ratio of thickness of the inner portion to the outer skin ranges from 01-10:1. The resulting SMC inner portion layer and outer skin layer are laid out, formed, and cured separately and the two layers joined thereafter to form a component. Such a two-piece component with an inner layer containing carbon fibers is noted to have a density that is 10, 20, 30 and even 40% lower than the comparable article formed wholly from TCA®. In this way, a lightweight article is formed that retains the high surface glass of a class-A surface associated with TCA®. It is appreciated that a given layer, can include both carbon fibers and glass fibers in combination, as well as other types of fibers such as natural cellulosic fibers that illustratively include coconut fibers with the proviso the loading of other types of fibers is limited such that glass fibers are predominantly present in a first layer and carbon fibers are predominantly present in a second layer. The predominant presence of a given type of fiber is used herein to mean that the fiber type represents more than 50% by weight of the total weight of fibers present in the layer. In certain embodiments, each layer is 100% of a given type of fiber, while in other embodiments the predominant fiber is present between 51 and 99%.

In another inventive embodiment, carbon fibers are dispersed in a methyl methacrylate monomer based molding composition. Other suitable monomers from which a molding composition formulation is produced illustratively include unsaturated polyesters, epoxies, and combinations thereof. A molding composition formulation based on epoxy illustratively includes bis-phenol-A and Novolac based 5 epoxy terminated resins. Suitable curing agents for such an epoxy based molding composition formulation illustratively include anhydrides such as trimellitic anhydride, methyl tetrahydrophthalic anhydride (MTHPA), nadic methyl anhydride (NMA), di- and tri-functional amines, and combinations thereof.

In another inventive embodiment of the present invention, carbon fibers are dispersed in a molding composition monomer or solution containing monomer with a relative polarity of greater than 0.26, and in certain embodiments greater than 0.5, and in still other embodiments between 0.5 and 0.8. Relative polarity is defined per Christian Reichardt, Solvents and Solvent Effects in Organic Chemistry, Wiley-VCH, 3rd edition, 2003.

In another inventive embodiment, the carbon fibers are dispersed in molding composition formulations prior to cure resulting in a reinforced SMC, BMC or RTM cured article that has a lower density overall, and a lower percentage by weight loading of fibers, as compared to a like layer formed with glass fiber reinforcement.

In certain inventive embodiments, heat is applied under suitable atmospheric conditions to remove any sizing or other conventional surface coatings on the surface of the carbon fibers prior to contact with a molding composition that upon cure forms a matrix containing the carbon fibers. In still other inventive embodiments heat is applied under an inert or reducing atmosphere to promote pyrolysis of the sizing from the core carbon fibers. It is appreciated that recycled carbon fiber is operative in an inventive two-piece vehicle component.

As carbon dissipates heat much better than glass as known from the respective coefficients of linear thermal expansion (CLTE), a predominantly carbon fiber filled layer cools more quickly than an otherwise like layer predominantly glass fiber filled. This difference in dynamic cooling after cure is compounded for thinner carbon fiber filled layers making them especially prone to warpage. Therefore, due to the differences in CLTE and material stiffness between the predominantly glass fiber filled layer and predominantly carbon filled layer, joining bonding agents must have exceptional elongation ability to compensate for the differential CLTE of the joined layers over the temperature range of −40 to 60° C., and even as high as 205° C. associated with cure conditions and hot joinder of layers. In specific inventive embodiments, elastomeric bonding agents may be used to bond the inner layer to the outer layer. Elastomeric bonding agents operative herein to join disparate layers of an inventive component illustratively include urethanes, epoxies, and a combination thereof. In certain inventive embodiments, the bonding flange thickness is increased from 6 to 13 millimeters (mm) for joining like fiber filler layers together to 2 to 4 centimeters for the inventive two-piece construction.

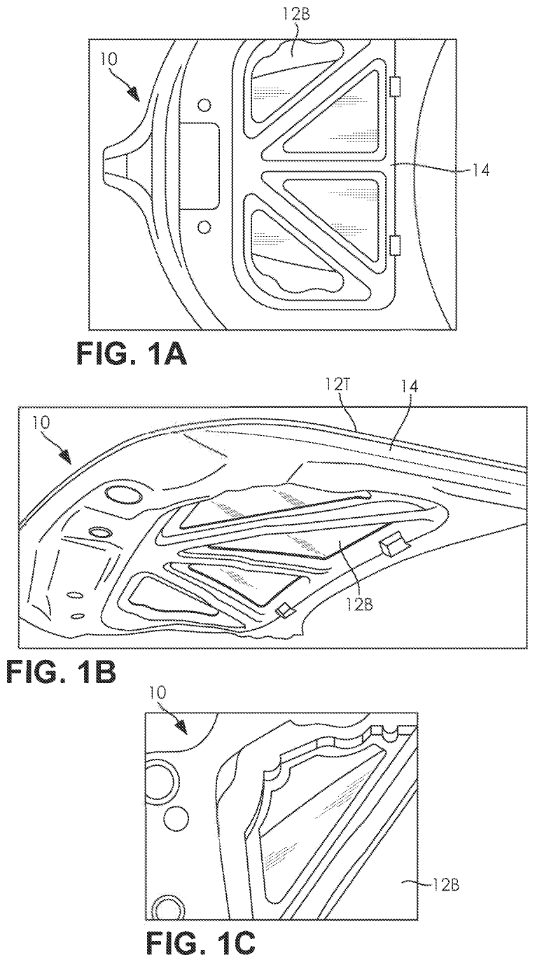

Referring now to FIGS. 1A-1C, an inventive two-piece component forms as a vehicle hood 10 is shown with an outer layer 12 (synonymously referred to herein as a first layer) of predominantly glass fiber reinforced sheet material has a surface gloss of conventional exterior vehicle automotive panels, and an inner layer 14 (synonymously referred to herein as a second layer) of predominantly carbon fiber reinforced sheet molding compositions. As shown, the outer layer 12 has a top portion 12T that is exposed as the outer finished surface of the vehicle, and a bottom portion 12B that is bonded to inner layer 14. The top portion 12T is amenable to sanding and painting to achieve a a surface gloss of conventional exterior vehicle automotive panels or similar high luster surface finish associated with a new vehicle exterior. Typical thickness of layers 12 and 14 in FIGS. 1A-1C are 2.5-2.7 millimeters (mm) and 1-2 mm, respectively. As noted above, it is appreciated that layers are joined to form more complex laminated of a cross-sectional ordering that illustratively include 12-14-12, 12-14-12-14, 12-14-(12-14)ₙ . . . 12 and 12-14-(12-14)ₙ, where n is an integer of n or more. It should also be appreciated that the thickness of layers 12 and 14 are variable depending on the desired strength and the overall laminate thickness so as to have values beyond the typical values provided above. In certain inventive embodiments, the article has a mirror plane of symmetry through the center of the laminate; for example, 12-12-14-14-12-12, 12-14-12, or 12-14-12-14-12-14-12. Without intending to be bound to a particular theory, a laminate with a mirror plane has equal opposing surface tension that offset to inhibit warpage.

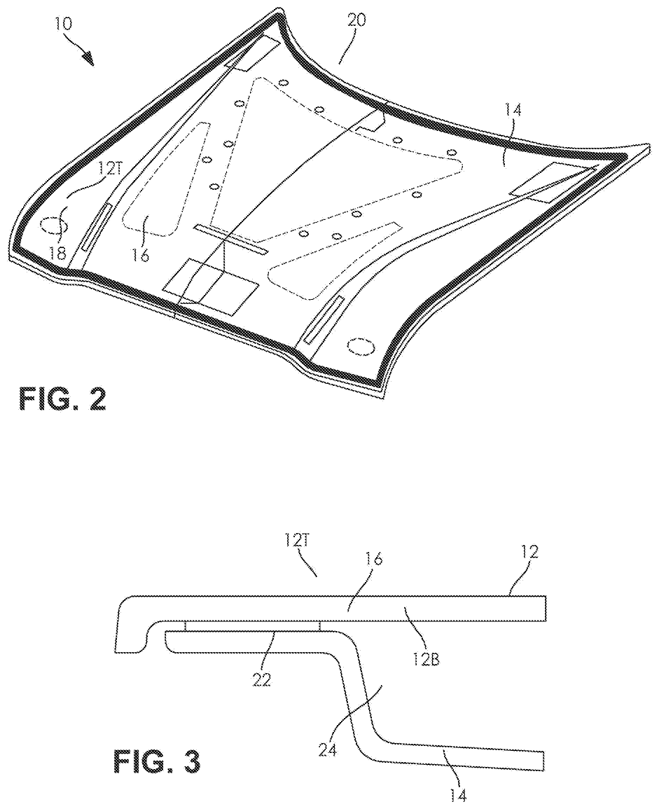

FIG. 2 shows the component 10 of FIG. 1 formed with a predominantly glass fiber reinforced finished surface outer layer 12 (shown as transparent for visual clarity) bonded at multiple points with the BLRT control adhesive to a predominantly carbon fiber reinforced structural inner panel 14 according to embodiments of the invention. It is appreciated that the inner layer 14 may be predominantly glass fiber filled. The inner layer 14 is bonded at various joints 16, or along a layer perimeter 18. Additionally, mastic drops 20 with BLRT control properties may provide spot adhesive bonding to modify joinder properties.

FIG. 3 is a cross section of a typical body panel seal flange where the glass fiber based class A outer layer 12 is bonded 16 with the BLRT control adhesive at a bond flange 22 of the carbon fiber based structural inner layer 14 according to embodiments of the invention. Vehicles are generally constructed around a frame, where a vehicle has finished surface panels that are secured or bonded to substructures to form body panels that are designed for attachment to the irregular surfaces of the frame. The bond flange 22 follows a corresponding seal carrying surface. The “hat” section 24 of the structural inner panel 14 extends to reach and attach to the frame (not shown).

### EXAMPLES

The present invention is further detailed with respect to the following non-limiting examples. These examples represent specific embodiments of the present invention and these examples are not intended to limit the scope of the appended claims.

### Example 1

An outer panel of a vehicle hood has a thickness of 10 mm and includes 30 volume percent of chopped glass fibers in a cured matrix of TCA® resin. The chopped glass fibers have a length of 25.4 mm and a diameter of 12 microns. An inner has a thickness of 8 mm and includes 15 volume percent of chopped carbon fibers and 15 volume percent of the chopped glass fibers used in the outer panel in a cured matrix of TCA® resin. The chopped carbon fibers have a length of 25.4 mm and a diameter of 6 microns. A liquid polyurethane adhesive is applied along a bond line having a width of 15 mm along a bond flange extending from the inner panel and contacting the outer panel. The adhesive has a Modulus of 680 MPa and a CLTE of 72 μm/m-° C. Upon adhesive set, no BLRT is observed with an unaided normal human eye at room temperature of 20° C.

### Example 2

The process of Example 1 is repeated with the adhesive joined hood cycled ten times between −40 and 40° C. before checking for BLRT at 20° C. with comparable results to Example 1.

### Comparative Example

The process of Examples 1 and 2 are repeated with a polyurethane having a Modulus of 500 MPa and a CLTE of 95 μm/m-° C. Upon adhesive set, a distinct BLRT pucker is observed in the outer panel along the flange joinder edges with an unaided normal human eye at room temperature of 20° C.

The foregoing description is illustrative of particular embodiments of the invention, but is not meant to be a limitation upon the practice thereof. The following claims, including all equivalents thereof, are intended to define the scope of the invention.

1. A vehicle component comprising:
a first cured layer of a molding composition having chopped glass fibers as a majority by volume of the fiber filler;
a second cured layer of molding composition having carbon fibers as a majority by volume of the fiber filler; and
an adhesive applied as liquid or paste joining said first cured layer and said second cured layer, said adhesive having a Modulus of between 600 and 800 MPa with an elongation of about 70% as determined by ASTM D638 and a CLTE between 50 and 90 μm/m-° C. in a temperature range of −30° C. to 0° C. and 255 μm/m-° C. in a temperature range of 100° C. to 130° C. as determined by ISO MAT-2208, and a thickness such that no bond-line read-through (BLRT) is observable in an outer surface of said first cured layer with an unaided, normal human eye.

2. The vehicle component of claim 1 wherein said second cured layer is substantially devoid of glass fiber.

3. The vehicle component of claim 1 wherein said adhesive is operative from −40 to 205° C.

4. The vehicle component of claim 1 wherein said adhesive is an elastomeric adhesive.

5. The vehicle component of claim 1 wherein said adhesive is applied on a bonding flange of between 2 and 4 centimeters in width.

6. The vehicle component of claim 1 wherein at least one of said first cured layer or said second cured layer comprises a minority percentage by total fiber weight of a natural fiber.

7. The vehicle component of claim 1 wherein said first cured layer is an outer panel of the vehicle.

8. The vehicle component of claim 1 wherein said second cured layer is an inner reinforcement panel of the vehicle.

9. The vehicle component of claim 1 wherein said first cured layer forms an outer skin layer surface of a vehicle and said second cured layer forms an interior layer.

10. The vehicle component of claim 9 wherein the outer skin layer surface has a new vehicle high gloss surface upon being painted.

11. The vehicle component of claim 9 wherein said interior layer has an inner layer thickness and said outer skin layer has an outer skin thickness and the ratio of the inner layer thickness to outer skin thickness is between 01-10:1.

12. The vehicle component of claim 1 wherein said molding composition is TCA®.
